(19) United States
(12) Patent Application Publication
(10) Pub. No.: US 2010/0058341 A1
(43) Pub. Date: Mar. 4, 2010

(54) APPARATUS AND METHOD FOR SETTING INPUT/OUTPUT DEVICE IN VIRTUALIZATION SYSTEM

(76) Inventors: Joonyoung JUNG, Daejeon-city (KR); Kiryong HA, Daejeon-city (KR); Jeunwoo LEE, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/506,312

(22) Filed: Jul. 21, 2009

(30) Foreign Application Priority Data
Aug. 28, 2008 (KR) 10-2008-0084762

(51) Int. Cl. G06F 9/455; G06F 3/00

(52) U.S. Cl. 718/1; 710/8

(57) ABSTRACT

A server in the virtualization system includes a plurality of virtual machines (VM) to construct a computing environment for every user, and allocates any one of the plurality of virtual machines to a user, when the user has access to the server. At this time, a plurality of peripheral apparatuses that are adjacent to the user are set as input/output devices of the virtual machines. According to an embodiment of the present invention, it is possible to construct an input/output computing environment of a virtual machine provided in a virtualization system by dynamically connecting a plurality of peripheral apparatuses around a user, thereby constructing a computing environment that is suitable for a peripheral situation of the user.

### RELATED APPLICATIONS

The present application claims priority to Korean Patent Application Serial Number 10-2008-0084762, filed on Aug. 28, 2008, the entirety of which is hereby incorporated by reference.

### BACKGROUND OF THE INVENTION

1. Field of the Invention

The present invention relates to an apparatus and method for setting an input/output device in a virtualization system, and more particularly, to an apparatus and method for setting an input/output device in a virtualization system that can dynamically set an input/output device of a virtual machine using user peripheral devices.

2. Description of the Related Art

In general, computing architecture that has been widely used is a client/server system. High-performance client computers that are installed in a server and client network environment in the related art need to individually install and execute software for each computer in order to use application software. In addition, a server only connects clients to a network or stores a shared file or program.

A server-based computing technology that performs most of the tasks in a server computer has been developed. This server-based computing technology is called a thin client computing environment. This system may be exemplified by a ‘terminal services’ provided by Microsoft. According to the server-based computing technology, an application program is executed in a server and a client can have access to the application program installed in the server through a terminal emulator without depending on a client device.

Accordingly, all tasks that a user generally performs using a terminal corresponding to the client are performed in the server and the task result is displayed on a screen of the terminal of the user. At the present time, all tasks that are performed in a personal computer (PC) are actually performed in the server. As a result, different from an existing PC, since the current PC does not need to mount a storage device, such as a hard disk or a floppy disk, cost of the client terminal can be reduced.

Further, the server-based computing technology provides an environment in which a plurality of users can have access to one server and can individually execute different application programs.

These terminal services are mounted in a server system based on Windows NT/2000/Net server OS provided by Microsoft. According to the terminal services, application programs that are needed in the server system are installed only once and the user executes an emulator by which the user can have access to the terminal services in his/her computer. The emulator that is executed in the user's computer is connected to the server through a network, enabling the application programs installed in the server system to be used.

However, a virtualization system that is used in the related art uses only a plurality of input/output devices that are set when a computing environment is constructed. Accordingly, in the constructed computing environment, even though a user peripheral environment is changed, devices around the user cannot be used by dynamically connecting the devices. When the user manually sets input/output devices again, the user can use the peripheral input/output devices. However, since the user needs to individually set the input/output devices again, this is inconvenient for the user.

### SUMMARY OF THE INVENTION

Accordingly, it is an object of the present invention to provide an apparatus and method for setting an input/output device in a virtualization system that can construct an input/output computing environment by dynamically connecting a plurality of peripheral apparatuses around a user, thereby constructing a computing environment that is suitable for a peripheral situation of the user.

In order to achieve the above-described object, an apparatus for setting an input/output device in a virtualization system according to one embodiment of the present invention is an apparatus for controlling an input/output device in a virtualization system that is connected to a plurality of peripheral apparatuses. The apparatus includes a communication module that transmits and receives data with the plurality of peripheral apparatuses; a management module that manages information of the plurality of peripheral apparatuses connected through the communication module; and a control module that allocates any one of a plurality of virtual machines, which are generated when the user has access, to a user and sets an input/output device of the virtual machine allocated to the user with respect to at least one of a plurality of peripheral apparatuses of the user.

The management module may generate a list of the plurality of peripheral apparatuses on the basis of profile information that is provided from the plurality of peripheral apparatuses of the user through the communication module.

The control module may select the peripheral apparatus, which is to be used as an initial input/output device, from the list of the plurality of peripheral apparatuses, and set the selected peripheral apparatus as the input/output device of the virtual machine. The control module may set at least one peripheral apparatus selected by the user from the list of the plurality of peripheral apparatuses as the input/output device.

The control module may provide access information for the virtual machine to at least one of the plurality of peripheral apparatuses. The virtual machine may transmit and receive input/output data with the peripheral apparatus that is set as the input/output device of the virtual machine among the plurality of peripheral apparatuses. At this time, input/output devices may not be set for the plurality of virtual machines that are generated when the user has access.

In order to achieve the above-described object, a method for setting an input/output device in a virtualization system according to another embodiment of the present invention is a method for setting an input/output device in a virtualization system that is connected to a plurality of peripheral apparatuses. The method includes generating a plurality of virtual machines where input/output devices are not set; allocating any one of the plurality of virtual machines to a user, when the user has access; searching a plurality of peripheral apparatuses adjacent to the user in order to set an input/output device of the virtual machine allocated to the user; and setting at least one of the plurality of searched peripheral apparatuses as the input/output device of the virtual machine allocated to the user.

The method may further include requesting to transmit profile information for the plurality of peripheral apparatuses adjacent to the user; and generating a list of the plurality of peripheral apparatuses using the profile information received from the plurality of peripheral apparatuses.

The method may further include transmitting and receiving input/output data with the peripheral apparatus that is set as the input/output device of the virtual machine.

According to the embodiments of the present invention, it is possible to construct an input/output computing environment of a virtual machine provided in a virtualization system by dynamically connecting a plurality of peripheral apparatuses around a user, thereby constructing a computing environment that is suitable for a peripheral situation of the user.

Further, since a plurality of peripheral apparatuses adjacent to a user in addition to a standardized apparatus allocated to a virtual machine can be used as input/output devices, it is possible to provide various input/output services.

### BRIEF DESCRIPTION OF THE DRAWINGS

FIG. 1 is a diagram illustrating the configuration of a virtualization system according to an embodiment of the present invention;

FIG. 2 is a block diagram illustrating the configuration of an apparatus for setting an input/output device in a virtualization system according to an embodiment of the present invention;

FIGS. 3A to 3C are diagrams illustrating the operation of an apparatus for setting an input/output device in a virtualization system according to an embodiment of the present invention; and

FIGS. 4 and 5 are flowcharts illustrating an operational flow of a method for setting an input/output device in a virtualization system according to an embodiment of the present invention.

### DESCRIPTION OF THE PREFERRED EMBODIMENTS

Hereinafter, the preferred embodiment of the present invention will be described in detail with reference to the accompanying drawings.

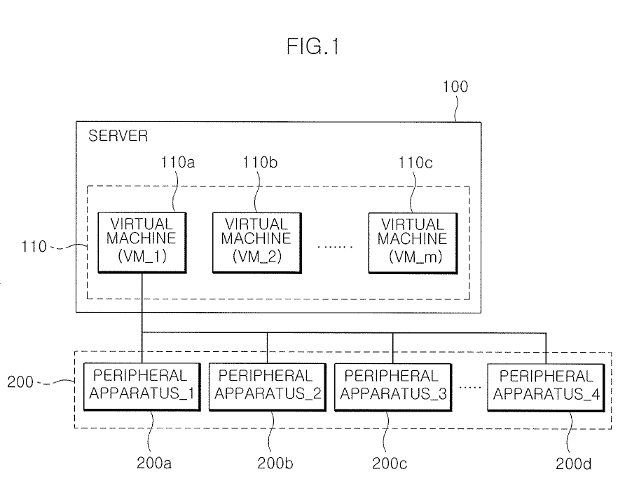

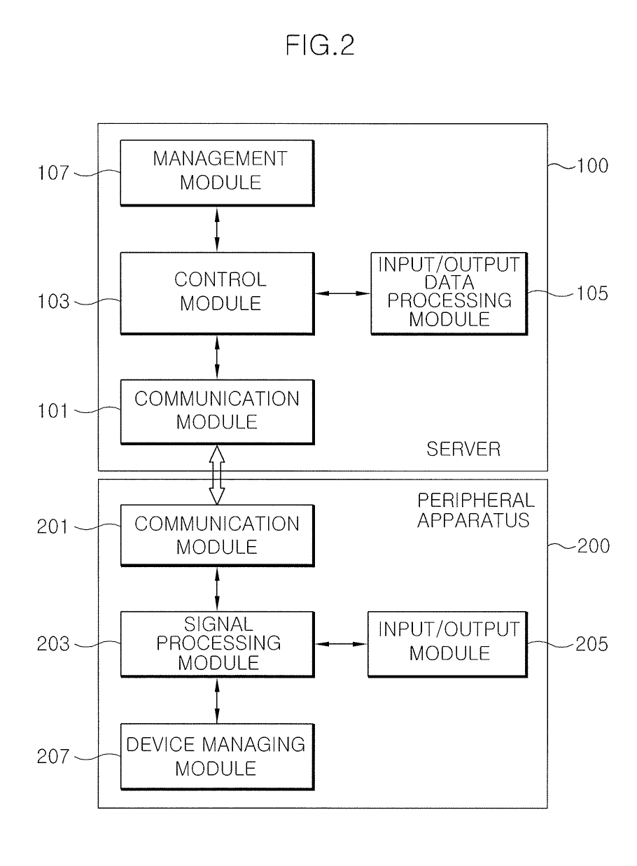

FIGS. 1 and 2 are diagrams illustrating the configuration of an apparatus for setting an input/output device in a virtualization system according to an embodiment of the present invention.

FIG. 1 shows the configuration of a virtualization system according to an embodiment of the present invention. As shown in FIG. 1, the virtualization system includes a server 100 that provides a predetermined service to a user. The server 100 includes a plurality of virtual machines (VM) 110 that construct an input/output computing environment for every user. At this time, the server 100 sets a computer environment except for input/output device information with respect to each of virtual machines 110a, 110b, and 110c, when the plurality of virtual machines 110 are generated.

When a user has access to the server 100, the server 100 provides any one of the plurality of virtual machines 110, and sets a plurality of peripheral apparatuses 200 adjacent to the user as input/output devices, through the provided virtual machine 110. That is, when the user has access to the virtual machine 110, the virtual machine 110 is dynamically connected to the plurality of peripheral apparatuses 200 around the user, and uses the corresponding peripheral apparatuses 200 to construct an input/output computing environment for the server 100. At this time, the virtual machine 110 transmits and receives input/output data with at least one peripheral apparatus 200 that is set as the input/output device. In this case, the plurality of peripheral apparatuses 200 may be apparatuses, such as a TV, a monitor, a PDA, an audio, a keyboard, a mouse, and a printer, which can generally input or output data.

The configuration of the apparatus for setting an input/output device in the virtualization system according to this embodiment will now be described in detail with reference to FIG. 2.

FIG. 2 is a block diagram illustrating the configuration of an apparatus for setting an input/output device in a virtualization system according to an embodiment of the present invention, which shows the configuration of a server and peripheral apparatuses.

First, the server 100 includes a communication module 101, a control module 103, an input/output data processing module 105, and a management module 107.

The communication module 101 is connected to at least one peripheral apparatus 200 and transmits and receives data with at least one peripheral apparatus 200.

The control module 103 controls connection with at least one peripheral apparatus 200, and processes a control message that is exchanged with at least one peripheral apparatus 200. That is, the control module 103 generates an informing message to inform an area where the server 100 exists and transmits the informing message to the outside through the communication module 101. The control module 103 responds to a connection request from the peripheral apparatus 200 using the informing message and allows the corresponding peripheral apparatus 200 to be connected to the server 100. At this time, the control module 103 periodically transmits the informing message for connection with the peripheral apparatus 200.

Further, when the control module 103 receives profile information from the connected peripheral apparatus 200, the control module 103 provides the received profile information of the corresponding peripheral apparatus 200 to the management module 107.

The management module 107 generates a list of peripheral apparatuses using the profile information of the corresponding peripheral apparatus 200, and manages the peripheral apparatus 200 that is included in the list of peripheral apparatuses. At this time, the management module 107 selects at least one peripheral apparatus 200 to be used as an input/output device from the list of peripheral apparatuses. Here, at least one peripheral apparatus 200 that is set as the input/output device may be automatically selected on the basis of the initially set criterion, arbitrarily selected, or selected by the user who has access to the server 100. That is, the selection criterion of the input/output device is not limited to a specific criterion, and may be changed according to the setting.

The control module 103 transmits connection information, such as a TCP port, which is used to transmit and receive input/output data between at least one peripheral apparatus 200 selected by the management module 107 and the virtual machine 110, to the corresponding peripheral apparatus 200.

Accordingly, the virtual machine 110 is connected to at least one selected peripheral apparatus 200 and sets the corresponding peripheral apparatus 200 as an input/output device, thereby constructing an input/output computing environment. For example, the virtual machine 110 may set a digital TV as a display unit, a printer as a printing unit, and a keyboard as an input unit. Further, the virtual machine 110 may set a personal terminal, such as a mobile phone and a PDA, as the input/output device. At this time, the virtual machine 110 can set the personal terminal as an additional storage unit as well as the input/output device in accordance with the setting.

The input/output data processing module 105 processes input/output data that is exchanged with the corresponding peripheral apparatus 200, on the basis of the input/output computing environment that is constructed by the virtual machine 110. That is, the input/output data processing module 105 processes data that is received from the peripheral apparatus 200 set as the input device and transmits output data from the server 100 to the peripheral apparatus 200 set as the output device, thereby allowing the data to be output through the corresponding peripheral apparatus 200.

Meanwhile, the peripheral apparatus 200 includes a communication module 201, a signal processing module 203, an input/output module 205, and a device managing module 207.

The communication module 201 is connected to the communication module of the server 100, and transmits input data to the server 100 or receives output data from the server 100.

The signal processing module 203 processes data that is transmitted and received through the communication module 201, and controls connection with the server 100. That is, when the signal processing module 203 receives an informing message informing an area of the server 100 from the server 100 through the communication module 201, the signal processing module 203 confirms the area of the server 100 from the received informing message and requests the server 100 for connection. At this time, when the signal processing module 203 receives a response signal from the server 100, the communication module 201 of the peripheral apparatus 200 and the communication module 101 of the server 100 are connected to each other.

Meanwhile, when the server 100 requests the signal processing module 203 to transmit profile information, the signal processing module 203 receives the profile information of the corresponding peripheral apparatus 200 through the device managing module 207 and transmits the profile information to the server 100. Further, when the corresponding peripheral apparatus 200 is set as the input/output device for the virtual machine 110 of the server 100, the signal processing module 203 transmits and receives input/output data with the virtual machine 110 of the server 100 through the communication module 201.

The input/output module 205 is connected to the input unit or the output unit of the peripheral apparatus 200, and processes data input from the input unit and provides the data to the signal processing module 203 or processes the data provided from the signal processing module 203 and outputs the data through the output unit.

The device managing module 207 manages profile information of the corresponding peripheral apparatus 200, and provides the profile information to the server 100 in accordance with a request from the server 100 that is connected through the communication module 201. Further, when the corresponding peripheral apparatus 200 is set as the input/output device from the virtual machine 110 of the server 100, the device managing module 207 manages connection information of the virtual machine 110 that is provided from the server 100.

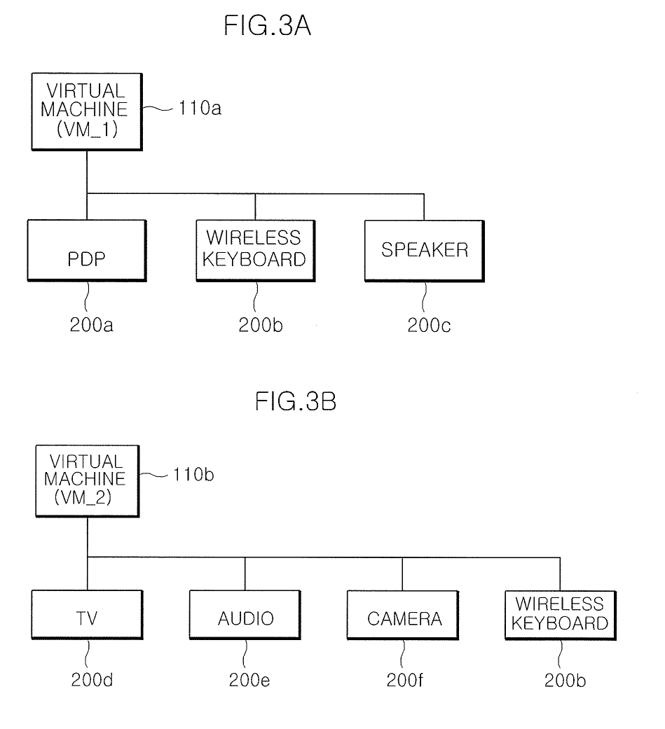

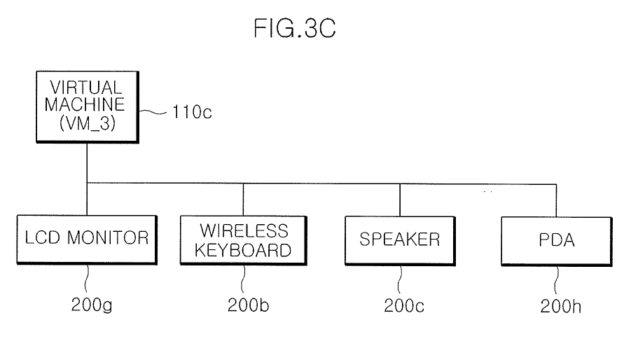

FIGS. 3A to 3C are diagrams illustrating the operation of an apparatus for setting an input/output device in a virtualization system according to an embodiment of the present invention.

Referring to FIGS. 3A to 3C, when a user has access to the server 100, the server 100 provides the virtual machine 110, which is selected from the plurality of virtual machines 110, to each user who has access to the server 100. At this time, the plurality of virtual machines 110 set the peripheral apparatus 200, which is adjacent to each user who has access to the server 100, as the input/output device, such that the plurality of virtual machines 110 transmit and receive input/output data with the corresponding peripheral apparatus 200. Here, each peripheral apparatus 200 may be connected to the plurality of virtual machines 110.

That is, among the plurality of virtual machines 110, one virtual machine (VM_1) 110a sets a PDP, a wireless keyboard, and a speaker, which are selected from the list of peripheral apparatuses, as input/output devices, thereby constructing an input/output computing environment. Accordingly, the virtual machine (VM_1) 110a transmits and receives input/output data with the PDP, the wireless keyboard, and the speaker.

Meanwhile, another virtual machine (VM_2) 110b sets a TV, an audio, a camera, and a wireless keyboard, which are selected from the list of peripheral apparatuses, as input/output devices, thereby constructing an input/output computing environment. Accordingly, the virtual machine (VM_2) 110b transmits and receives input/output data with the TV, the audio, the camera, and the wireless keyboard.

Meanwhile, another virtual machine (VM_3) 110d sets an LCD monitor, a wireless keyboard, a speaker, a PDA, which are selected from the list of peripheral apparatuses, as input/output devices, thereby constructing an input/output computing environment. Accordingly, the virtual machine (VM_3) 110d transmits and receives input/output data with the LCD monitor, the wireless keyboard, the speaker, and the PDA.

Here, the wireless keyboard and the speaker are repetitively connected to the virtual machine (VM_1) 110a, the virtual machine (VM_2) 110b, and the virtual machine (VM_3) 110d, and the speaker is repetitively connected to the virtual machine (VM_1) 110a and the virtual machine (VM_3) 110d.

The operation according to this embodiment that has the above-described structure will now be described.

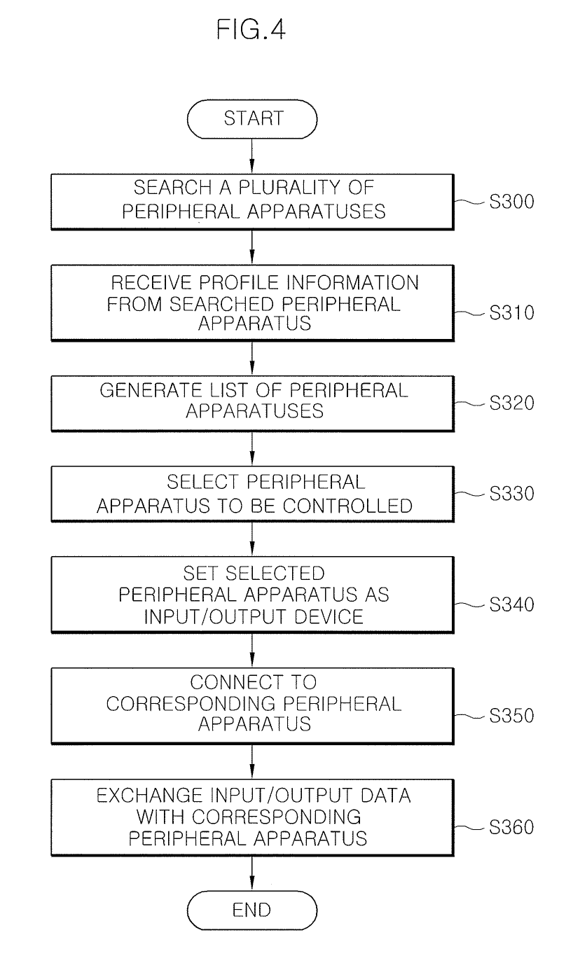

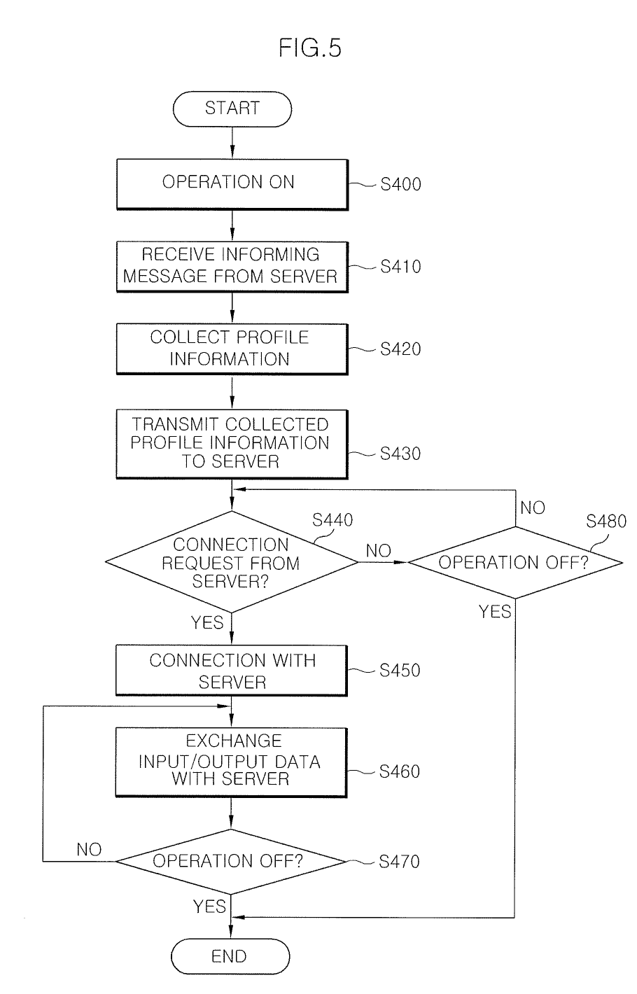

FIGS. 4 and 5 show an operational flow of a method for setting an input/output device in a virtualization system according to an embodiment of the present invention.

FIG. 4 shows an operational flow of a server when a user has access to the server. As shown in FIG. 4, the virtual machine 110 that is provided to the user who has access to the server 100 searches the plurality of peripheral apparatuses 200 around the user (S300). At this time, if at least one peripheral apparatus 200 is searched, the virtual machine 110 collects profile information from the searched peripheral apparatus 200 (S310). Here, the virtual machine 110 generates a message that informs the area of the server 100 and outputs the message to the outside. The virtual machine 110 is connected to the peripheral apparatus 200 that has received the message in response to a connection request from the corresponding peripheral apparatus 200. At this time, the virtual machine 110 transmits a message requesting to transmit profile information to the corresponding peripheral apparatus 200, and the peripheral apparatus 200 collects the profile information and transmits a transmission message including the profile information to the virtual machine 110.

The virtual machine 110 generates a list of peripheral apparatuses for the plurality of peripheral apparatuses 200, on the basis of the profile information collected from the plurality of peripheral apparatuses 200 (S320). The virtual machine 110 sets at least one peripheral apparatus 200, which is selected from the generated list of peripheral apparatuses, as the input/output device of the server 100 (S330). Further, the virtual machine 110 requests the peripheral apparatus 200 set as the input/output device for connection (S340). At this time, when the corresponding peripheral apparatus 200 responds to the connection request, the virtual machine 110 is connected to at least one peripheral apparatus 200 (S350), and transmits and receives input/output data with the corresponding peripheral apparatus 200 (S360).

For example, when the connected peripheral apparatus 200 is an input device, such as a keyboard or a mouse, the virtual machine 110 receives data input from the connected peripheral apparatus 200 and performs a corresponding operation. When the connected peripheral apparatus 200 is an output device, such as a monitor or a printer, the virtual machine 110 transmits output data to the peripheral apparatus 200, thereby allowing the data to be output through the corresponding peripheral apparatus 200. Meanwhile, when the connected peripheral apparatus 200 has functions of the input device and the output device, the connected peripheral apparatus can perform the corresponding functions.

FIG. 5 is a flowchart illustrating an operational flow of peripheral apparatuses around a user in accordance with a request from the user. As shown in FIG. 5, in a state where the peripheral apparatus 200 in an ON state (S400), if the informing message is received from the virtual machine 110 of the server 100 (S410), the peripheral apparatus 200 responds to the informing message, collects profile information of the peripheral apparatus 200 (S420), and transmits the collected profile information to the virtual machine 110 (S430).

If a connection request is transmitted from the virtual machine 110 (S440), the peripheral apparatus 200 is connected to the virtual machine 110 in response to the connection request from the virtual machine 110 (S450). Accordingly, the peripheral apparatus 200 transmits and receives the input/output data through the virtual machine 110 (S460), until a separate operation completion command is input (S470). Meanwhile, if the connection request is not transmitted from the virtual machine 110 after the process of Step ‘S430’, the peripheral apparatus 200 performs a corresponding operation in accordance with an external control command, or completes the operation if an operation completion command is input (S480).

The apparatus and method for setting an input/output device in the virtualization system according to the embodiment of the present invention have been described with reference to the accompanying drawings. However, the present invention is not limited thereto, and various changes and modifications can be made without departing form the spirit and scope of the present invention.

What is claimed is:

1. An apparatus for setting an input/output device in a virtualization system that is connected to a plurality of peripheral apparatuses, the apparatus comprising:
a communication module that transmits and receives data with the plurality of peripheral apparatuses;
a management module that manages information of the plurality of peripheral apparatuses connected through the communication module; and
a control module that allocates any one of a plurality of virtual machines, which are generated when the user has access, to a user and sets at least one of a plurality of peripheral apparatuses as an input/output device of the virtual machine allocated to the user.

2. The apparatus of claim 1,
wherein the management module generates a list of the plurality of peripheral apparatuses on the basis of profile information that is provided from the plurality of peripheral apparatuses through the communication module.

3. The apparatus of claim 2,
wherein the control module selects the peripheral apparatus, which is to be used as an initial input/output device, from the list of the plurality of peripheral apparatuses, and sets the selected peripheral apparatus as the input/output device of the virtual machine.

4. The apparatus of claim 2,
wherein the control module sets at least one peripheral apparatus selected by the user from the list of the plurality of peripheral apparatuses as the input/output device.

5. The apparatus of claim 1,
wherein the control module provides access information for the virtual machine to at least one of the plurality of peripheral apparatuses.

6. The apparatus of claim 1,
wherein the virtual machine transmits and receives input/output data with the peripheral apparatus that is set as the input/output device of the virtual machine among the plurality of peripheral apparatuses.

7. The apparatus of claim 1,
wherein input/output devices are not set for the plurality of virtual machines that are generated when the user has access.

8. A method for setting an input/output device in a virtualization system that is connected to a plurality of peripheral apparatuses, the method comprising:
generating a plurality of virtual machines where input/output devices are not set;
allocating any one of the plurality of virtual machines to a user, when the user has access;
searching a plurality of peripheral apparatuses adjacent to the user; and
setting at least one of the plurality of searched peripheral apparatuses as the input/output device of the virtual machine allocated to the user.

9. The method of claim 8, further comprising:
requesting to transmit profile information for the plurality of peripheral apparatuses adjacent to the user; and
generating a list of the plurality of peripheral apparatuses using the profile information received from the plurality of peripheral apparatuses.

10. The method of claim 8, further comprising:
transmitting and receiving input/output data with the peripheral apparatus that is set as the input/output device of the virtual machine.
